(19) United States
(12) Patent Application Publication
(10) Pub. No.: US 2012/0122436 A1
(43) Pub. Date: May 17, 2012

(54) HANDS FREE NOTIFICATION

(75) Inventor: Ioannis PERRAKIS, Athens (GR)

(73) Assignee: NOKIA SIEMENS NETWORKS OY, Espoo (FI)

(21) Appl. No.: 13/376,726

(22) PCT Filed: Jun. 12, 2009
(86) PCT No.: PCT/EP09/57280

§ 371 Date: Jan. 13, 2012

(51) Int. Cl. H04W 68/00

(52) U.S. Cl. 455/414.1

(57) ABSTRACT

The present invention provides a mechanism that enables a called party mobile device 108 to provide a notification in the backward direction via a terminating switch 106 and an originating switch 104 to a calling party communication device 102. The notification will indicate to a calling party 101 whether or not the called party 109 is currently using a hands free device with their mobile device 108.

The present invention relates to providing a notification to a calling party indicating the hands free status of the called party.

In certain situations it may be dangerous, if not illegal in some jurisdictions, for a called party to use a mobile device (e.g. a mobile phone) without a hands free device (e.g. a Bluetooth headset, a hands free car kit and so on) when, for example, the called party is operating a motorised vehicle such as driving a car. In present telecommunication networks a calling party, whether they are making a call from a mobile or fixed device, does not know whether or not the called party is currently using a hands free device. Therefore, if the calling party may believe that the user they are calling may be performing a certain task, such as driving a car, then the calling party does not know whether it is safe to continue with the call.

In existing telecommunication systems there is currently no mechanism to provide a notification to the calling party indicating whether the called party, a user with a mobile device, is at that time using a hands free device. In particular, the current protocols such as ISDN User Part (ISUP), Bearer Independent Call Control (BICC) or Session Initiation Protocol (SIP) between the Mobile Switching Centre (MSC), hosting the called party, and the originating switch, hosting the calling party, do not currently provide means for providing a notification to the calling party's device regarding whether the called party is using a hands free device. Thus, there is a need to enable the calling party to be notified whether or not a called party is using a hands free device.

According to a first aspect of the present invention there is provided a method of operating a switch comprising: receiving a first message from a called party mobile device wherein the first message includes a hands free status for the called party mobile device; and transmitting a second message to a second switch operatively connected to a calling party communication device wherein the second message is modified based on the hands free status.

The hands free status may provide an indication as to whether a hands free device is operatively connected to the called party mobile device.

The method may further comprise processing the first message to determine the hands free status; and the step of modifying the second message comprises including a parameter in the second message wherein the parameter defines the hands free status.

Thus, the switch serving the called party mobile device will receive a message from the called party mobile device that provides a hands free status information of the called party mobile device. The switch can then propagate in the backward direction, in other words back towards the calling party, a message that has been modified based on the hands free status. The second message that is modified is typically a standard message based on the signaling protocol implemented between the first and second switch which relates to the standard mechanism for setting up a call between the calling party and the called party. For example, if the signaling protocol between the first switch and the second switch is based on ISUP then the second message may be an Address Complete Message and the parameter is a generic notification indicator parameter inserted or included in the Address Complete Message. However, if the signaling protocol used is SIP then the second message that will be modified will be the SIP:180 Ringing message. Accordingly, the present invention can be implemented in a telecommunication network irrespective of the actual signaling protocol used. Thus, the embodiments of the present invention provide a new mechanism for providing an indication or notification of the hands free status of a called party mobile device to the switch serving the calling party communication device. The switch serving the calling party communication device may then provide an indication of the hands free status to the calling party's communication device.

According to a second aspect of the present invention there is provided a switch operatively connected to a called party mobile device that is adapted to receive a first message from a called party mobile device wherein the first message includes a hands free status for the called party mobile device; and transmit a second message to a second switch operatively connected to a calling party communication device wherein the second message is modified based on the hands free status.

The hands free status may provide an indication as to whether a hands free device is operatively connected to the called party mobile device.

The switch may be further adapted to process the first message to determine the hands free status; and the switch may be further adapted to modify the second message by including a parameter in the second message wherein the parameter corresponds to the hands free status.

As a person skilled in the art will appreciate, the switch may be adapted to perform the invention by installing or running the appropriate computer readable executable code on the switch to perform the required functions.

According to a third aspect of the present invention there is provided a computer program product comprising computer readable executable code configured to receive a first message from a called party mobile device wherein the first message includes a hands free status for the called party mobile device; and transmit a second message to a second switch operatively connected to a calling party communication device wherein the second message is modified based on the hands free status.

The computer program product may comprise computer readable executable code for performing any or all of the functions in accordance with the aspects of the invention.

According to a fourth aspect of the present invention there is provided a method of operating a switch operatively connected to a calling party communication device comprising: receiving a first message from a second switch operatively connected to a called party mobile device wherein the first message includes a parameter that defines a hands free status of the called party mobile device; and transmitting a second message to the calling party communication device wherein the second message includes an indication of the hands free status of the called party mobile device.

The hands free status may provide an indication as to whether a hands free device is operatively connected to the called party mobile device.

Thus, a switch serving the calling party communication device will receive a message from a switch serving a called party mobile device where the message has been modified to include a parameter that defines the hands free status of the called party mobile device. The switch serving the calling party communication device can then propagate in the backward direction, in other words to the calling party communication device, a message that includes an indication of the hands free status of the called party mobile device. Thus, the calling party communication device is then able to provide an indication or notification of the hands free status of the called party mobile device to the calling party.

The message received by the switch serving the calling party communication device is typically a standard message based on the signaling protocol implemented between the first and second switch which relates to the standard mechanism for setting up a call between the calling party and the called party but has been modified to include the hands free status of the called party mobile device. For example, if the signaling protocol between the switches is based on ISUP then the received message may be an Address Complete Message and the parameter is a generic notification indicator parameter inserted or included in the Address Complete Message. However, if the signaling protocol used is SIP then the second message that will be modified will be the SIP:180 Ringing message. Accordingly, the present invention can be implemented in a telecommunication network irrespective of the actual signaling protocol used. Thus, the embodiments of the present invention provide a new mechanism for providing an indication or notification of the hands free status of a called party mobile device to the calling party communication device.

According to a fifth aspect of the present invention there is provided a switch operatively connected to a calling party communication device adapted to: receive a first message from a second switch operatively connected to a called party mobile device wherein the first message includes a parameter that defines a hands free status of the called party mobile device; and transmit a second message to the calling party communication device wherein the second message includes an indication of the hands free status of the called party mobile device.

The hands free status may provide an indication as to whether a hands free device is operatively connected to the called party mobile device.

As a person skilled in the art will appreciate, the switch may be adapted to perform the invention by installing or running the appropriate computer readable executable code on the switch to perform the required functions.

According to a sixth aspect of the present invention there is provided a computer program product comprising computer program executable code configured to: receive a first message from a second switch operatively connected to a called party mobile device wherein the first message includes a parameter that defines a hands free status of the called party mobile device; and transmit a second message to the calling party communication device wherein the second message includes an indication of the hands free status of the called party mobile device.

The computer program product may comprise computer readable executable code for performing any or all of the functions in accordance with the aspects of the invention.

According to a seventh aspect of the present invention there is provided a method of operating a called party mobile device comprising: receiving a setup message from a switch wherein the setup message includes data for setting up a call with a calling party communication device; determining a hands free status of the called party mobile device; and transmitting a message to the switch wherein the message includes an indication of the hands free status based on the determination of the hands free status of the called party mobile device.

The step of determining the hands free status of the called party mobile device may comprise determining whether a hands free device is operatively attached to the called party mobile device.

Thus, in response to receiving a call set up request from a switch serving the called party mobile device, it will determine the hands free status of the called party mobile device, e.g. whether or not a hands free device is operationally connected to the mobile device, and transmit the hands free status to the switch. Accordingly, this will enable the calling party to be informed of the hands free status of the called party mobile device at the time that the calling party is calling the called party.

According to an eighth aspect of the present invention there is provided a mobile device adapted to: receive a setup message from a switch wherein the setup message includes data for setting up a call with a calling party communication device; determine a hands free status of the called party mobile device; and transmit a message to the switch wherein the message includes an indication of the hands free status based on the determination of the hands free status of the called party mobile device.

The hands free status of the called party mobile device is determined by the mobile device being further adapted to determine whether a hands free device is operatively attached to the called party mobile device.

As a person skilled in the art will appreciate, the mobile device may be adapted to perform the invention by installing or running the appropriate computer readable executable code on the switch to perform the required functions.

According to a ninth aspect of the present invention there is provided a computer program product comprising computer program executable code configured to: receive a setup message from a switch wherein the setup message includes data for setting up a call with a calling party communication device; determine a hands free status of the called party mobile device; and transmit a message to the switch wherein the message includes an indication of the hands free status based on the determination of the hands free status of the called party mobile device.

The computer program product may comprise computer readable executable code for performing any or all of the functions in accordance with the aspects of the invention.

Embodiments of the present invention will now be described, by way of example only, and with reference to the drawings, in which:

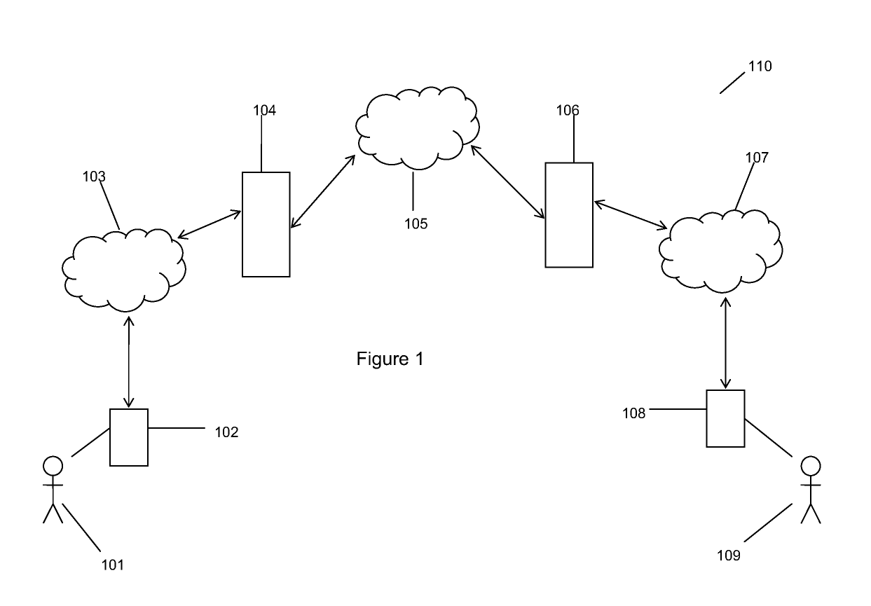

FIG. 1 shows a schematic view of the system in accordance with aspects of the invention.

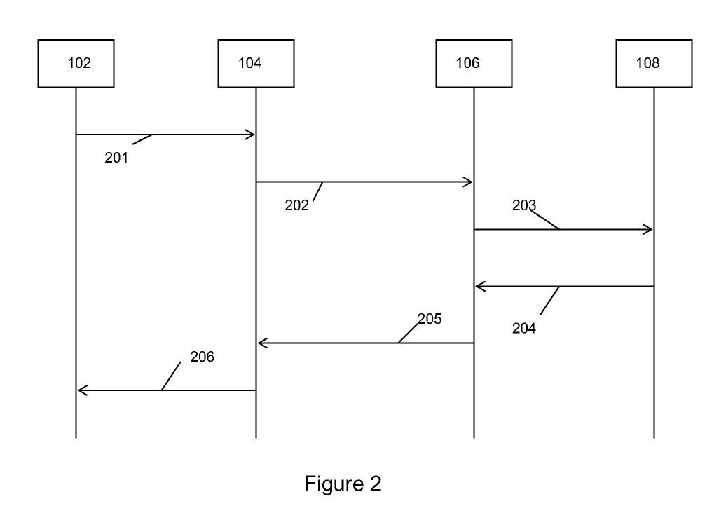

FIG. 2 shows a message flow diagram in accordance with aspects of the invention.

In the embodiments of the present invention, which will be described with reference to FIG. 1 and FIG. 2, a calling party receives a notification that provides an indication to the calling party as to whether a called party is using a hands free device with their mobile device.

In the embodiments a Hands Free Notification to Calling Party (HFNCP) service is provided in the telecommunication network 110 by a network operator in which a mobile device user 109 with a subscription with the network operator can add the HFNCP service to their subscription. The HFNCP service enables the called party's mobile device 108 to provide a notification to a calling party's communication device 102 indicating whether or not a hands free device is being used by the called party 109. The notification may take the form of a visual indication, such as a message displayed on the calling party's communication device 102, or the notification may take the form of an audio indication, such as a particular tone, or the notification may take the form of a physical stimulus, such as a vibration of the calling party's communication device 102, or the notification may take the form of a combination of any or all of the different notification forms mentioned above.

The mobile device user 109 (i.e. the called party) subscribed to the HFNCP service may activate or deactivate the HFNCP service and may also interrogate the HFNCP service to determine the status of the HFNCP service, e.g. to determine whether the HFNCP service is active or not by using access codes that are recognised by the HFNCP service. For example, the mobile device user 109 could enter an access code *44 to activate the HFNCP service or enter an access code *45 to deactivate the HFNCP service or enter an access code *46 in order to receive an indication of the status of the HFNCP service.

If the mobile device user 109 has activated the HFNCP service then a notification will be provided to the calling party 101 that indicates whether the called party 109, i.e. the mobile device user 109, is using a hands free device with their mobile device 108, e.g. a mobile phone.

A calling party 101, using a fixed or mobile communication device 102, initiates a telephone call with the mobile device user 109, e.g. the called party, by going “off-hook” which is detected by a switch 104 serving the calling party's communication device 102 and the dial tone is provided to the calling party 101. The calling party 101 then dials the telephone number associated with the called party's mobile device 108 which is transmitted 201 to the switch 104 which for this call is called an originating switch 104. The calling party's communication device 102 typically communicates with the originating switch 104 over an access network 103.

The originating switch 104 will generate and transmit 202 a message based on the communication and signalling protocol used in a core network 105 to reserve a communication path between the originating switch 104 and a terminating switch 106. The terminating switch 106 in the embodiments will be a Mobile Switching Centre (MSC) switch 106 serving the mobile device 108 of the called party 109. The protocol on which the communication and signalling is based between the originating 104 and terminating 106 switches can be any protocol, e.g. ISUP, SIP, BICC and so on that is implemented in the network 105. For example, if the protocol is ISUP then the message would be ISUP:IAM (Initial Address Message) but if the protocol is SIP then the message would be SIP:INVITE.

The message transmitted 202 from the originating switch 104 to the terminating switch 106 will be used to reserve a communication path between the switches for the call between the calling party 101 and the called party 109 and to inform the terminating switch 106 of the called party number along with any additional optional information such as the calling party name and number.

The terminating switch 106 on receipt of the message will examine the dialed telephone number in order to determine that it serves the called party's mobile device 108 and that the mobile device 108 is available for ringing. The terminating switch 106 then causes 203 the mobile device 108 to ring and if available from the message received from the originating switch 104 also transmit 203 information regarding the calling party's telephone number over the access network 107.

The process in setting up the call between a calling party 101 and a called party 109 is well known in the art to a skilled person and so has not been described in great detail. Moreover, in the conventional systems the called party's mobile device 108 will simply acknowledge to the terminating switch 106 that the mobile device 108 is ringing and the terminating switch 106 will send a message to the originating switch 104 indicating that the communication path has been reserved for the call. The originating switch 104 will then cause the calling party's communication device 102 to provide the ringing tone to the calling party 101 and the call can then continue once the called party 109 answers the call.

However, in the embodiments of the present invention when the terminating switch 106 (e.g. the MSC switch) causes the called party's mobile device 108 to ring then the mobile device 108 will further determine the hands free status of the called party mobile device 108. For example, if the called party 109 is currently using a hands free device then the ‘hands-free’ indication on the mobile device 108 will be set to ‘true’ whilst if the called party 109 is not currently using a hands free device then the ‘hands-free’ indication on the mobile device 108 will be set to ‘false’. On acknowledging the call setup and ringing instruction from the terminating switch 106 the mobile device 108 will also transmit 204 over the access network 107 the hands free status of the mobile device 108 to the terminating switch 106.

HFNCP service logic located on the terminating switch 106 will process the received hands-free status and modify the message that will be transmitted 205 to the originating switch 104 based on the hands-free status of the called party mobile device 108. In other words, the terminating switch 106 generates and transmits 205 the message required by the signalling protocol implemented between the originating 104 and terminating 106 switches but modifies that message based on the received hands free status so that the message will include a parameter that defines and corresponds to the hands free status of the called party's mobile device 108.

For example, if the signalling between the originating switch 104 and the terminating switch 106 is based on the ISUP protocol then the HFNCP service logic on the terminating switch 106 modifies the standard ISUP:ACM (Address Complete Message) to include a Generic Notification Indicator (GNI) parameter that defines and corresponds to the hands free status of the called party's mobile device 108. The GNI parameter will be set to ‘hands-free is on’ if the received hands-free status from the called party's mobile device 108 is ‘true’ or set to ‘hands-free is off’ if the received hands-free status from the called party's mobile device 108 is ‘false’.

Similarly, if the signalling between the originating switch 104 and the terminating switch 106 is based on SIP then the standard SIP:180 Ringing message will accordingly be modified to include a parameter that defines and corresponds to the hands-free status of the called party's mobile device 108.

The originating switch 104 serving the communication device 102 of the calling party receives the message from terminating switch 106 and processes the message. The message comprises the standard information and parameters informing the originating switch 104 that the communication path for the call being set up has been reserved and causes the originating switch 104 to provide the ringing tone to the calling party. The processing of the received message by the originating switch 104 also includes interpreting the parameter that defines the hands-free status of the called party's mobile device that is included within the received message. The originating switch 104 determines from the received message whether or not a hands free device is being used by the called party 109 with their mobile device 108. The originating switch 104 will then transmit 206 over the access network 103 a notification or indication of the hands free status to the communication device 102 of the calling party 101. The hands free notification may be provided to the calling party 101 by, for example, in the form of a visual indication such as a message that states whether the hands free device is on or the hands free device is off or in the form of an audio indication, for example, a predetermined tone for hands free on and a different predetermined tone for hands free off. The communication device 102 of the calling party is also provided with a ringing tone indicating that the called party's mobile device 108 is ringing.

If the called party 109 has de-activated the HFNCP service then the HFNCP service may either automatically return a hands free off notification to the calling party 101 or provide no notification or indication to the calling party 101 of whether or not the called party 109 is using a hands free device with their mobile device 108.

As a person skilled in the art will appreciate the HFNCP service may be implemented in any telecommunication network using different signalling protocols, for example ISUP, SIP, BICC and so on, by adapting or modifying the appropriate well known messages to include the hands free notification in the backward direction from the called party's mobile device 108 to the calling party's communication device 102.

Accordingly, the preferred embodiments of the present invention provides a mechanism that enables a called party using a mobile device to provide a notification as to whether they are currently using a hands free device with their mobile device to a calling party. Thus, the calling party can advantageously decide whether or not to continue with the call to the called party if the calling party knows or suspects that the called party is performing a task, such as driving a car, where it is not safe for the called party to talk without a hands free device.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and scope of the invention.

1. A method of operating a switch comprising:
receiving a first message from a called party mobile device wherein said first message includes a hands free status for said called party mobile device; and
transmitting a second message to a second switch operatively connected to a calling party communication device wherein said second message is modified based on said hands free status.

2. The method as claimed in claim 1 in which said hands free status provides an indication as to whether a hands free device is operatively connected to said called party mobile device.

3. The method as claimed in claim 1 further comprises:
processing said first message to determine said hands free status; and said step of modifying said second message comprises including a parameter in said second message wherein said parameter corresponds to said hands free status.

4. A switch operatively connected to a called party mobile device adapted to:
receive a first message from a called party mobile device wherein said first message includes a hands free status for said called party mobile device; and
transmit a second message to a second switch operatively connected to a calling party communication device wherein said second message is modified based on said hands free status.

5. The switch as claimed in claim 4 in which said hands free status provides an indication as to whether a hands free device is operatively connected to said called party mobile device.

6. The switch as claimed in claim 4 in which said switch is further adapted to process said first message to determine said hands free status; and said switch is adapted to modify said second message by including a parameter in said second message wherein said parameter corresponds to said hands free status.

7. A computer program product comprising computer readable executable code configured to:
receive a first message from a called party mobile device wherein said first message includes a hands free status for said called party mobile device; and
transmit a second message to a second switch operatively connected to a calling party communication device wherein said second message is modified based on said hands free status.

8. A method of operating a switch operatively connected to a calling party communication device comprising:
receiving a first message from a second switch operatively connected to a called party mobile device wherein said first message includes a parameter that defines a hands free status of said called party mobile device; and
transmitting a second message to said calling party communication device wherein said second message includes an indication of said hands free status of said called party mobile device.

9. The method as claimed in claim 8 in which said hands free status provides an indication as to whether a hands free device is operatively connected to said called party mobile device.

10. A switch operatively connected to a calling party communication device adapted to:
receive a first message from a second switch operatively connected to a called party mobile device wherein said first message includes a parameter that defines a hands free status of said called party mobile device; and
transmit a second message to said calling party communication device wherein said second message includes an indication of said hands free status of said called party mobile device.

11. A computer program product comprising computer program executable code configured to:
receive a first message from a second switch operatively connected to a called party mobile device wherein said first message includes a parameter that defines a hands free status of said called party mobile device; and
transmit a second message to said calling party communication device wherein said second message includes an indication of said hands free status of said called party mobile device.

12. A method of operating a called party mobile device comprising:
receiving a setup message from a switch wherein said setup message includes data for setting up a call with a calling party communication device;
determining a hands free status of said called party mobile device; and
transmitting a message to said switch wherein said message includes an indication of said hands free status based on said determination of said hands free status of said called party mobile device.

13. The method as claimed in 12 in which said step of determining said hands free status of said called party mobile device comprises determining whether a hands free device is operatively attached to said called party mobile device.

14. A mobile device adapted to:
receive a setup message from a switch wherein said setup message includes data for setting up a call with a calling party communication device;
determine a hands free status of said called party mobile device; and
transmit a message to said switch wherein said message includes an indication of said hands free status based on said determination of said hands free status of said called party mobile device.

15. The mobile device as claimed in 14 in which said hands free status of said called party mobile device is determined by said mobile device being further adapted to determine whether a hands free device is operatively attached to said called party mobile device.

16. A computer program product comprising computer program executable code configured to:
receive a setup message from a switch wherein said setup message includes data for setting up a call with a calling party communication device;
determine a hands free status of said called party mobile device; and
transmit a message to said switch wherein said message includes an indication of said hands free status based on said determination of said hands free status of said called party mobile device.
